(19) United States
(12) Patent Application Publication
(10) Pub. No.: US 2019/0234842 A1
(43) Pub. Date: Aug. 1, 2019

(54) SYSTEM, METHOD AND KIT FOR SAMPLE PREPARATION

(71) Applicant: Ventana Medical Systems, Inc., Tucson, AZ (US)

(72) Inventors: EMILY S. ALKANDRY, ROCKVILLE, MD (US); CHRISTOPHER LAWRENCE DONAT, TUCSON, AZ (US); MELIS HAZAR, TUCSON, AZ (US); RAYMOND T. KOZIKOWSKI, III, TUCSON, AZ (US); ESTEBAN ROBERTS, TUCSON, AZ (US); MOHAMED A. SAKR, PHILADELPHIA, PA (US)

(21) Appl. No.: 16/376,001

(22) Filed: Apr. 5, 2019

Related U.S. Application Data
(63) Continuation of application No. PCT/US2017/055503, filed on Oct. 6, 2017.
(60) Provisional application No. 62/405,129, filed on Oct. 6, 2016.

(51) Int. Cl. G01N 1/31; B01L 3/00

(52) U.S. Cl. CPC G01N 1/312; B01L 3/5027; B01L 2400/0406; B01L 2300/1805; B01L 2300/0867

(57) ABSTRACT

A system, method and kit for preparing a cellular biological sample are disclosed. In a particular embodiment, the disclosed system (200) is configured to mate with a substrate (208), such as a microscope slide, and provide the fluidics that can be used to perform a particular sample preparation protocol. The disclosed system is particularly suited for use in a point-of-care setting, such as in a surgical suite or in a resource-limited or remote setting where automation of the sample preparation protocol is not a viable alternative.

### RELATED APPLICATION DATA

The present application is a continuation of International Application No. PCT/US2017/055503 filed on Oct. 6, 2017, which claims the benefit of U.S. Provisional Patent Application No. 62/405,129, filed Oct. 6, 2016, the disclosures of which are each hereby incorporated by reference herein in their entireties.

### FIELD

The disclosure relates to a system and method for preparing substrate mounted biological samples for analysis, more particularly, the disclosure relates to a system and method for immunohistochemical (IHC) staining of cellular samples mounted on microscope slides.

### BACKGROUND

Complex automated systems for consistent preparation of substrate-mounted cellular samples for microscopic analysis are often cost prohibitive for small and resource-poor laboratories. Furthermore, certain settings preclude the use of automation. For example, automated slide staining systems are not typically co-located where patients are cared for due to safety and contamination concerns. Manual procedures for preparing samples, on the other hand, are typically labor intensive and prone to variability if not performed by a skilled technician. As such, samples are routinely transported from the point of patient care to a specialized laboratory for automated or even manual preparation. Transport of samples can lead to a significant delay in receipt of sample test results, particularly in locations where the site of patient care is very remote from any specialized laboratory having the equipment and/or skilled personnel needed to reliably prepare the samples for analysis.

### SUMMARY

Disclosed is a system and a method for preparing cellular samples (such as tissue and cytological samples) for microscopic analysis that can be utilized by relatively unskilled technicians in any setting.

In one aspect of the present disclosure are systems, kits, and methods that can be used for preparing substrate-mounted cellular samples at or near the point-of-care of a patient, or in laboratories where sample volumes are too low to justify a large investment in automation, or where resources are otherwise limited. In particular embodiments, the disclosed system, kit and method can be used to prepare stained cellular samples for microscopic analysis. In other particular embodiments, the disclosed system, kit and method may help bring the advantages of automation to smaller, low-volume laboratories in a simpler form.

In another aspect, a system is disclosed for preparing a cellular biological sample for analysis, wherein the cellular biological sample is mounted on a substrate. The system includes an introducer assembly configured to receive at least one fluid used to prepare the cellular sample for analysis. A conveyor assembly is included to move the at least one fluid across at least a portion of the substrate and bring the at least one fluid in contact with at least a portion of the cellular biological sample. A substrate mating assembly of the system is configured to hold the substrate against at least a portion of the conveyor assembly. In particular embodiments, the introducer, conveyor and substrate mating assembly are combined in a monolithic structure that can be attached to a substrate to ready the system for sample preparation. In other particular embodiments, the system is modular. For example, one or more of the introducer assembly, the conveyor assembly, the substrate mating assembly, and/or one or more parts or components of each thereof, can be combined into two or more modules, which modules can be assembled, along with a substrate such as a microscope slide, into a system that is ready for use to prepare a sample. In more particular embodiments, the particular combination of modules used is dependent upon a desired sample treatment protocol.

In another aspect, a method is disclosed for preparing a cellular sample for microscopic analysis, wherein the cellular sample is mounted to a microscope slide. The method includes mating the system of any of claims 1 to 28 with the microscope slide to which the cellular sample is adhered, delivering, through the introducer assembly, a predetermined series of reagents to a sample treatment portion of the conveyor assembly that covers at least a portion of the cellular sample and brings the predetermined series of reagents into contact with the cellular sample, and, removing, successively, the series of reagents from the sample treatment portion into a collector assembly of the conveyor assembly.

In a third aspect, a kit is provided, the kit including he disclosed system, along with instructions for its use.

### BRIEF DESCRIPTION OF THE DRAWINGS

The features and advantages of the disclosed system and method will become further apparent from the detailed description when read in light of the accompanying drawings, in which:

FIG. 1 shows a schematic of the disclosed system, including some features of particular disclosed embodiments.

FIG. 2 shows a perspective diagram of a particular embodiment of the disclosed system including a porous membrane conveyor feature.

FIG. 3 shows a perspective diagram of a particular embodiment of the disclosed system including a capillary conveyor feature.

FIG. 4 shows an exploded view of a particular embodiment of the disclosed system including a capillary conveyor feature and multiple absorbent pads.

FIG. 5 shows a perspective view of the system of FIG. 4 as assembled for use in preparing a sample for analysis.

FIG. 6 shows an exploded view of another embodiment of the disclosed system including multiple reagent introduction inlets.

FIG. 7 shows a perspective view of a particular embodiment of the disclosed system including top and bottom assemblies that engage with a substrate.

FIG. 8 shows an exploded view of another embodiment of the disclosed system including an adhesive substrate mating assembly portion and pads containing dried reagents.

FIG. 9 shows the embodiment of FIG. 8 in assembled form.

FIG. 10 shows an embodiment of the disclosed system where the introducer assembly, conveyor assembly and the substrate mating assembly are combined in a monolithic assembly.

FIG. 11 illustrates an embodiment of a sample treatment portion of the conveyor having a particular configuration.

FIG. 12 illustrates another embodiment of a sample treatment portion of the conveyor assembly including capillary passages that fluidically couple the sample treatment portion to a collector assembly.

FIG. 13 illustrates yet another embodiment of a sample treatment portion of the conveyor assembly.

FIG. 14 shows an exploded view of yet another embodiment of the disclosed system.

FIG. 15 shows the embodiment of FIG. 14 in assembled form.

FIG. 16 shows an exploded view of a monolithic embodiment of the disclosed system.

FIG. 17 shows the embodiment of FIG. 16 in assembled form.

FIG. 18 shows an exploded view of a modular embodiment of the disclosed system.

FIG. 19 shows the embodiment of FIG. 18 in assembled form.

FIG. 20 shows an exploded view of another modular embodiment of the disclosed system including a clamping assembly.

FIG. 21 shows the embodiment of FIG. 20 in assembled form.

FIG. 22 shows an embodiment of a reagent releaser for sequential delivery of multiple reagents.

FIG. 23 shows a process map for the sample preparation functions that can be performed utilizing certain embodiments of the disclosed system.

FIG. 24 shows a process map of an exemplary immunohistochemical staining procedure that can be performed employing the disclosed system.

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

A system for preparing a cellular biological sample for analysis, wherein the cellular biological sample is mounted on a substrate. As used herein, “a cellular biological sample,” or simply “sample,” comprises any sample that includes prokaryotic and/or eukaryotic cells or significant fragments thereof. Particular examples of cellular biological samples include tissue sections, cytology samples, and microbiological samples.

The disclosed system includes an introducer assembly that is configured to receive at least one fluid used to prepare the cellular biological sample for analysis, such as for microscopic analysis. The system further includes a conveyor assembly configured to move the at least one fluid across at least a portion of the substrate and bring the at least one fluid in contact with at least a portion of the cellular biological sample. The system further includes a substrate mating assembly configured to hold the substrate against at least a portion of the conveyor assembly.

In particular embodiments of the disclosed system, at least a portion of each of the introducer assembly, the conveyor assembly and the substrate mating assembly are combined in a single, pre-assembled unit. In other particular embodiments, the substrate comprises a microscope slide (such as a standard 1-inch by 3-inch glass or plastic microscope slide).

In other particular embodiments of the disclosed system, the introducer assembly comprises one or more fluid inlets that can be used to introduce liquid reagent directly, or can contain a dried reagent retained within the inlet such that addition of a solvent, such as a buffer, cause the reagent to dissolve in the solvent and be carried through the system. In more particular embodiments, the introducer assembly comprises two or more fluid inlets. In other more particular embodiments, the introducer assembly further comprises indicia that specify the order in the at least one fluid is introduced into the two or more fluid inlets of the introducer assembly, perhaps according to some instructions. For example, the introducer assembly can include a set of numbers or symbols printed hear the two or more inlets that indicate the order in which a solvent is added to each of the inlets in order to perform a sample preparation procedure according to a pre-determined order of steps.

In other embodiments, the system further includes a fluid delivery control unit configured to mate with the one or more fluid inlets of the introducer assembly of the system. For example, the fluid delivery control unit can automatically supply the at least one fluid to the introducer assembly of the system in one or more predetermined amounts at one or more predetermined times into one or more pre-determined inlets of the introducer assembly. In other embodiments, the fluid delivery control unit can comprise an interface that directs a user to add one or more fluids in a particular order to one or more inlets. In a more particular semi-automated example, tthe at least one fluid, the one or more predetermined amounts and the one or more predetermined times are encoded in indicia on the system and read by an indicia reader of the fluid delivery control unit, thereby causing the fluid delivery control unit to supply the at least one fluid to the introducer assembly according to the one or more predetermined amounts and at the one or more predetermined times.

In other embodiments, the introducer assembly further includes at least one reagent releaser. Examples of reagent releasers a dried reagent printed on a surface of the introducer assembly, a dissolvable polymer comprising a reagent, a porous membrane pad comprising a reagent, a particle comprising a reagent, and a blister pack comprising a pre-mixed reagent or solvent to dissolve a dried reagent.

In more particular embodiments, the introducer assembly includes at least one valve configured to alter a flow pattern of the at least one fluid through the introducer assembly after a predetermined length of time. Examples of valves that can alter the flow pattern to, for example, deliver a predetermined series of reagents to the cellular biological sample that performs a sample preparation procedure, include dissolvable valves such as those disclosed in Gerbers et al., Lab Chip, 2014, 14, 4042-4049, the contents of which are incorporated by reference herein.

In another embodiment of the disclosed system, the conveyor assembly includes a fluid collector assembly. The fluid collector can be, for example, a reservoir or an adsorbent material. The conveyor assembly can include a porous membrane and/or a capillary channel that, in some embodiments, forms a sample treatment portion of the conveyor assembly. In further embodiments, the collector assembly comprises a porous material and is configured to draw the at least one fluid from the introducer assembly, through the conveyor assembly and into the collector assembly.

In still other embodiments, the substrate mating assembly comprises an adhesive material attached to a surface of the conveyor assembly. In more particular embodiments of the disclosed system, at least one capillary channel is defined by a combination of the substrate, the adhesive material and the surface of the introducer assembly and or the conveyor assembly. In even more particular embodiment, the system further includes a removable covering over the adhesive material that protects the adhesive material until it is used to join the substrate to the conveyor assembly and/or the introducer assembly.

In order to assist a user in assembly of the system, the conveyor assembly and/or the introducer assembly can include guide portions that assist a user in combining the substrate with the conveyor assembly and/or the introducer assembly to form a system prepared to accept the one or more fluids. For example, the substrate mating assembly can include a backing plate such as a backing plate that includes a holding portion configured to accommodate the substrate and that can be further configured to align the substrate with the conveyor assembly when the backing plate and the conveyor assembly are combined.

In order to help ensure a good seal between the substrate and the system, the substrate mating assembly can further include a clamping assembly configured to apply a force that holds the substrate against the substrate mating assembly. In more particular embodiments, the clamping assembly can be configured to include a fluid deliver unit as discussed above.

Heating and cooling of a cellular biological sample can be aspects of a sample preparation protocol such as a staining protocol. As such the clamping assembly can be configured to include a temperature regulating subsystem. Alternatively, the conveying assembly and/or a backing plate can further include at least one heating and/or cooling element. In more particular embodiments, the clamping assembly can further include electrical connectors or other interconnects to connect or otherwise communicatively couple the at least one heating and/or cooling element in the conveying assembly and/or a backing plate.

In another aspect, a method for preparing a cellular sample for microscopic analysis is disclosed, and, in particular, a method for preparing a cellular sample that is mounted to a microscope slide. The disclosed method comprising includes mating any of the embodiments of the disclosed system with the microscope slide to which the cellular sample is adhered and delivering, through the introducer assembly, a predetermined series of reagents to a sample treatment portion of the conveyor assembly that covers at least a portion of the cellular sample and brings the predetermined series of reagents into contact with the cellular sample. The method further includes removing, successively, the series of reagents from the sample treatment portion into a fluid collector assembly of the conveyor assembly. In a particular embodiment, the predetermined series of reagent comprises a series of reagents to perform a staining protocol on the cellular sample, for example, an immunohistochemical staining protocol. In another particular embodiment, the cellular sample comprises a tissue sample such as a frozen tissue section or a paraffin-embedded tissue section (which has been deparaffinized).

In another aspect, a kit is disclosed that includes an embodiment of the disclosed system and instructions for using the system to perform a particular sample preparation protocol, such as a staining protocol. In particular embodiments, the disclosed kit further includes a microscope slide, such as a microscope slide that is treated (such as with poly-lysine, fibronectin, laminin, collagen or a silanization reagent) to improve adherence of cells to the microscope slide.

### EXAMPLES

The disclosed device can provide staining for rapid turnaround, low cost, low volume applications at the patient point-of-care (POC). Today's POC technology in tissue diagnostics is limited to H&E and it is very manual process where user has large number of touch points. Examples of use cases for the disclosed system, method and kit include POC IHC in the surgical suite for rapid turn-around-time of IHC markers on frozen sections, where they can be used to inform surgical and concomitant treatment decisions on the spot without the burden of brining patient back in the surgical room. Another use case is POC IHC for emerging markets.

Overall, the disclosed device can be configured to be single test kit where the handheld POC device does not require an expensive automation platform but rather it is simple enough for anyone to run the assay using the kit for surgical support or in a low resource/mobile laboratory setting.

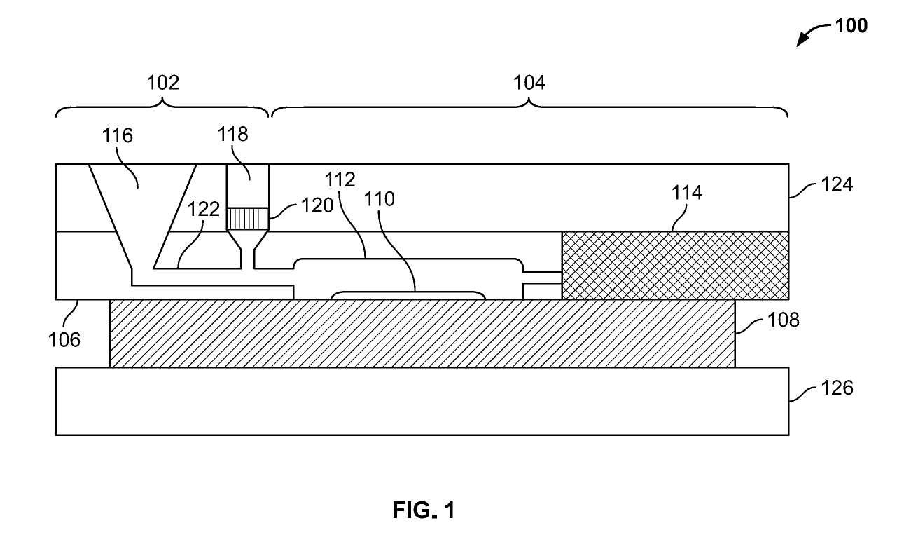

With reference now to FIG. 1, the disclosed system 100 can include an introducer assembly 102, a conveyor assembly 104 and a substrate mating assembly 106 that mates with substrate 108. In this embodiment, both the introducer assembly and the conveyor assembly are combined in a single housing 124. An optional backing plate 126 can be included to hold or otherwise position the substrate 108 in the correct location relative to the housing 124.

The function of the introducer assembly is to accept sample preparation fluids from user in a single or multiple steps. In some embodiments, the introducer portion includes one or more channels 122. For example, the introducer assembly can include multiple individual channels stacked in the z direction, one for each fluid, and a user times their delivery. In such an embodiment, each reagent has its own channel so no washing of channels is required between steps.

Alternatively, there can be a single channel for introduction of all the fluids, with washing in between fluid introductions. While such a simple design is cheaper to manufacture, and possibly smaller, washing between reagents typically demands more usage of wash fluid.

Other embodiments for the introducer assembly include multi-channel devices that utilize valves and timing of dissolution of reagents to automatically time the fluid delivery to the sample. For example, channels be placed side-by-side. Alternatively, the user can time the reagents. Yet another possible embodiment is a system that includes a continuous flow interface (such as to an IV line), which is good for wash and buffer solutions as they will be used in higher volumes. While the height difference of the IV line will affect the flow in the tube, this can be mitigated by user training and provision of a stand that is used to keep the height difference constant.

In another embodiment, a user may pipette or otherwise deposit predetermined volumes into an inlet 116 or 118, which inlet can lead through a passage 122, such as a capillary passage, into a sample treatment portion 110 of the conveyor assembly 104 where the fluid comes into contact with a cellular biological sample 112. Also, part of the conveyor assembly 104 can be collector assembly 114, which might be an absorbent pad that receives fluid from the sample treatment portion 110 and provides a motive force to move fluids from the introducer assembly 102 through the sample treatment portion 110. In some instance, one or more inlets 118 of the introducer assembly 102 can include a reagent releaser 120 that dissolves when a fluid is added to the inlet. In other embodiments, the reagent releaser can be a blister that a user can burst into the device manually or semi-automatically. Multiple blisters can be incorporated to deliver fluids to device inlets, and such blisters can also be utilized to pre-mix reagents prior to introduction to the device.

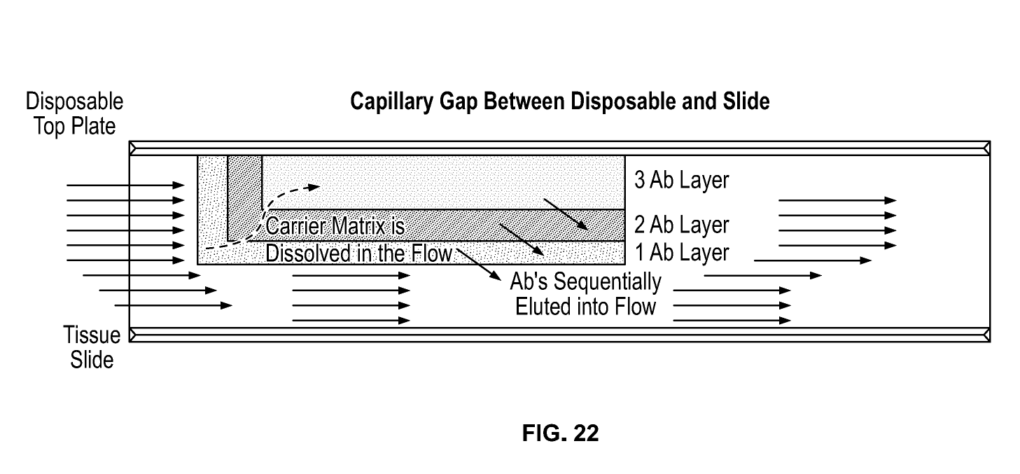

The function of the reagent releaser is to preserve labile biologic reagents over time, and under heat and/or mechanical force. The releaser can hold a desired amount of reagent and allow for control release thereof. Reagents can, for example, be printed onto a surface of the disclosed system using inkjet technologies and dried. Alternatives include dissolvable polymer films that can be packed into the system and can be activated with buffer solution. Conjugate pads, onto which reagents can be dried onto the conjugate pads and then released with a buffer solution or other solvent are other alternatives. Yet another alternative is that reagents are provided in liquid aliquot form and come with the device in a kit and the user introduces them to the device. Still another alternative are particles that have tailored release of reagents. A 3D reagent releaser can be used to provide automated timing of delivery of multiple different reagents as a buffer or other solvent flows through the device (see, for example, FIG. 22 and associated discussion below)

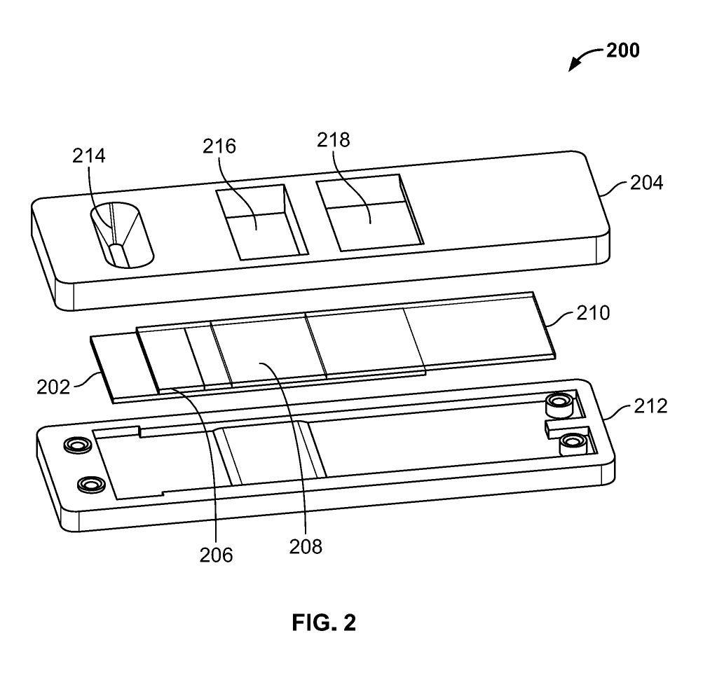

The function of the conveyor assembly is to move fluid through different components of the device including, for example, from introducer assembly to reagent releaser, releaser to sample, and sample to waste. One option to provide this motive force is to include one or more porous membrane portions in the system. A membrane is a passive way of moving fluid. The dry membrane wicks the fluid and wicking moves the fluid to desired location. FIG. 2 illustrates an embodiment of the disclosed system that includes a membrane moving fluids. System 200 of FIG. 2 includes a top housing portion 204, and bottom housing portion 212. A substrate 208, such as a microscope slide, is held in bottom housing portion 212 and when top housing portion 204 is snapped into place, membrane portions 202, 206, and 210 are brought into contact with substrate 208. In this embodiment, membrane portion 202 is positioned such that a fluid added to inlet 214 is wicked from membrane portion 202 into membrane portion 206 and across the surface of the substrate 208 where the sample is located to membrane portion 210 that functions as a collector of waste fluids. Such a configuration offers the advantage that bubble formation is kept to a minimum, but there is interaction between the membrane and the sample. Additional inlets or observation windows 216 and 218 can be included in the top portion 204. Sample treatment reagents and control reagents can be included in the membrane portions.

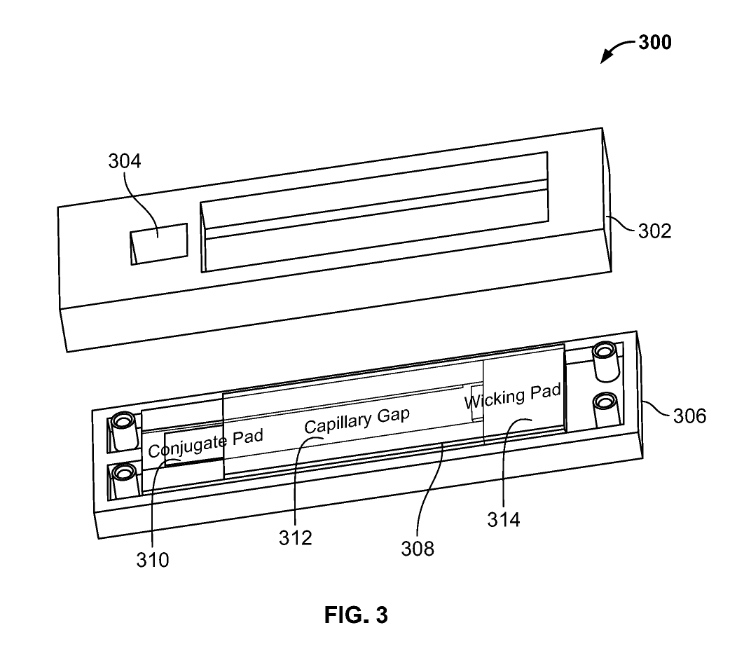

Turning now to FIG. 3, the conveyor assembly can include a capillary gap to move fluid across a sample held on a substrate. In this particular embodiment, system 300 includes a top housing portion 302 and bottom housing portion 306. In the embodiment of FIG. 3, a substrate such as microscope slide 308 is placed so that the sample bearing side is facing toward the bottom housing portion 306. Spacers position the substrate above the bottom housing portion to form a capillary gap 312. Conjugate pad 310 is position in proximity to inlet 304 such that a fluid added to the inlet is dissolved from the conjugate pad and carried through the capillary gap, past the sample, and into wicking pad 314.

Another possible way to move fluid through the disclosed device is utilizing pressure. This is an active way to move the fluid, more suitable for a semi-automated benchtop version of the disclosed system. Pressure driven flow can, for example, be created with syringe pump. Active motivation of fluids can provide faster flow rates and require less tight tolerances in the device, but electricity may be required. Yet another way to move fluid through the disclosed device is utilizing an electric field, which can also provide faster and more controlled flow rates, and less tight tolerances for manufacturing, but electricity is required. Still another alternative is to utilize gravity, as alluded to above. For example, the system can be provided with a tilt to move the fluid. Finally, a user can dispense fluids directly onto the sample on the substrate. While direct dispense permits the device to be simpler, it does create additional user touch points.

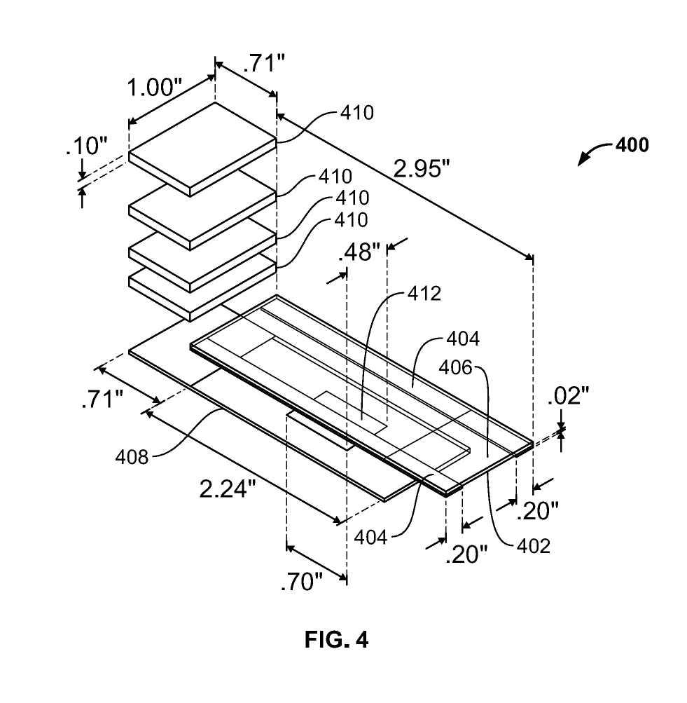

It should be noted that any hybrid combination of these various arrangements to add and move fluids are possible. For example, capillary forces can be used to deliver a fluid to a sample on a substrate, but removed using a wicking force. FIG. 4 illustrates such a configuration. In system 400, a capillary gap forming member 402 having gap forming spacers 404 (which can be adhesive, such as double sided adhesive) is placed in contact with a substrate 408. In this embodiment, the spacers form the substrate mating assembly. The capillary gap forming member 402 is configured to extend beyond a first end of the substrate to provide a fluid application portion 406 that represents the introducer assembly. At a second end of the substrate, one or more wicking pads 410 are placed (also perhaps with an adhesive) to receive fluid that passes through the capillary space past sample 412. Depending upon the waste volume generated during a particular sample preparation protocol, the number of stacked wicking pads can be adjusted to provide enough motive force to flow the fluid at an appropriate rate through the device. In this embodiment, the combination of the capillary space and the wicking pads represents the conveyor assembly, and the wicking pads represent the collector assembly. In use, once the sample treatment protocol is completed, a user can simply remove the capillary gap forming member 402 and the wicking pads 410 and the prepared sample can be examined, such as microscopically.

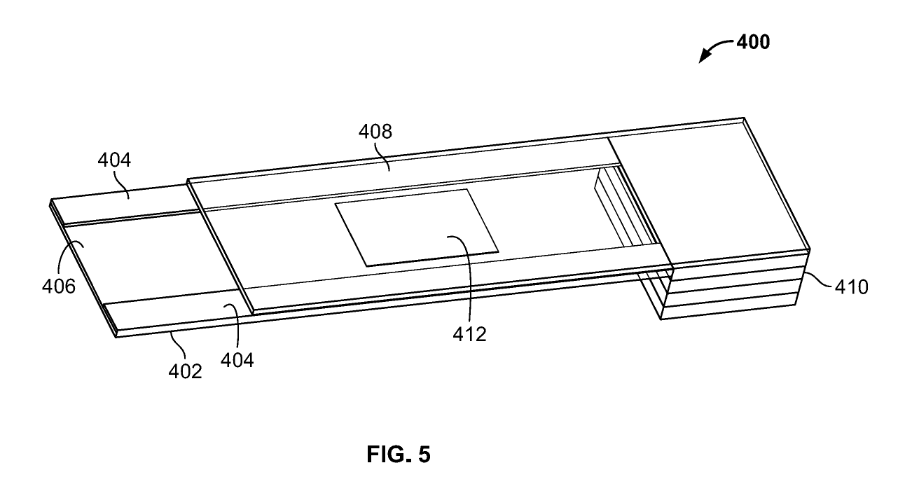

FIG. 5 shows the system of FIG. 4 in an assembled form, wherein like reference numerals indicate like elements.

Options for the collector assembly, which serves to remove and possibly hold waste fluids, include absorbent wicking pads (such as made from cellulose), a hydrogel, a container (such as filled by a vacuum), or simply permit evaporation at an outlet to reduce waste volume.

While the embodiments illustrated in FIGS. 4 and 5 depict no housing, the skilled artisan will appreciate that a housing can be part of the disclosed system. The housing can function to interface with the slide for alignment purposes, for helping create a seal, and it can be made cheaply to permit cost-effective disposal; and it also serves to protect a sample during treatment. In various embodiments, all or part of a housing can be constructed of glass, molded plastic, a 3D printed polymer or co-polymer, polydimethylsiloxane (“PDMS”), and other known materials such as metals, metal alloys, and machined plastics.

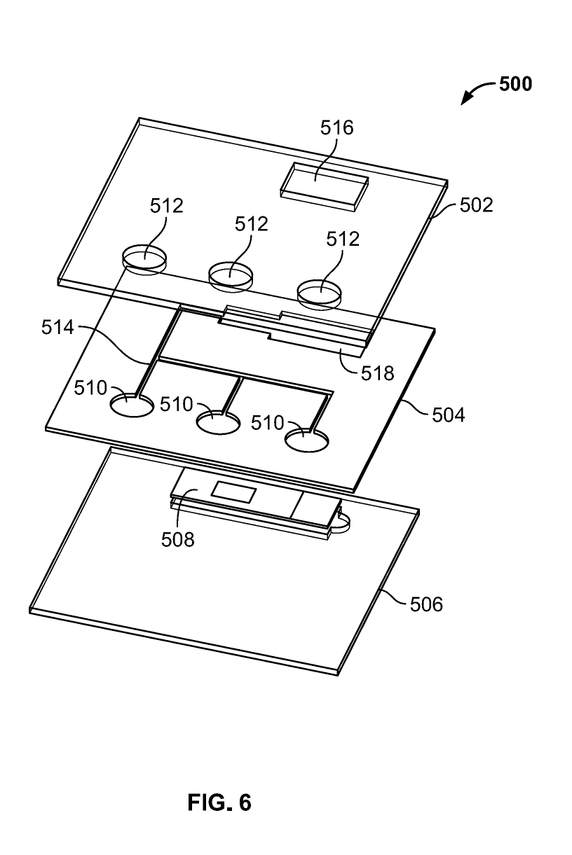

The embodiments of FIGS. 4 and 5 provide one dimensional fluid conveyance through the system, however, such systems are not limited to one dimensional fluid flow. Indeed, as shown in FIG. 6, the disclosed system can include 2-dimensional fluid handling capabilities. In system 500, a top introducer assembly housing 502 including fluid inlets 512 and wicking pad window 516 is attached to a substrate mating assembly, which in this instance is a piece of double sided tape. The top assembly and the tape can be combined with a wicking pad and provided along with the bottom housing portion 506. A polymer or paper covering can be left on the lower side of the double-sided tape until a user is ready to assemble and utilize the device. In this instance, a user would place a substrate bearing a sample in a substrate holding portion (not shown) of the bottom housing portion 506, remove the covering over the lower side of the double-sided tap and place the top introducer assembly housing 502 over the substrate and the bottom housing portion. Capillary channels 514 that are formed between the top and bottom housing portions, and defined by the paths in the tape, are used to convey reagent fluids from inlets 512 to a sample treatment portion of the conveyor assembly (not shown). Waste fluids are further conveyed into and absorbed by a wicking pad placed (or pre-placed) in the wicking pad window.

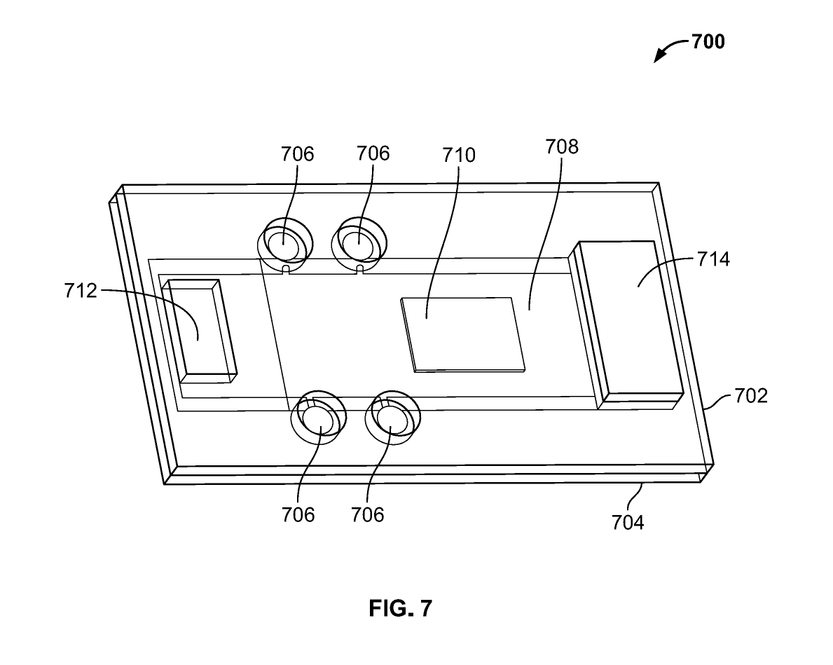

FIG. 7 illustrates another embodiment of the disclosed system including top and bottom housing portions 702 and 704, where the top housing portion includes biologic reagent inlets 706, wash fluid inlet 712, and wicking pad 714. Fluids introduced into any of the inlets are conveyed through a capillary space over substrate 708 bearing sample 710 to wicking pad 714.

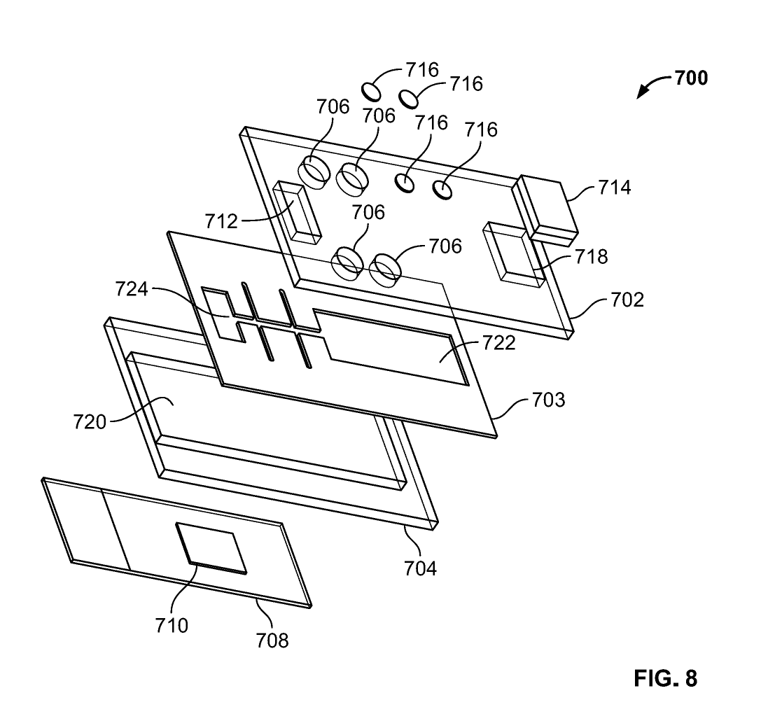

FIG. 8 shows an exploded view of another embodiment of the disclosed system that is similar to that of the embodiment of FIG. 7 except that the inlets 706 are connected to the sample treatment portion 722 of the conveyor assembly by longer capillary channels. Like reference numerals in FIG. 8 as in FIG. 7 correspond to similar elements. What is further shown in FIG. 8 is a substrate holding portion 720 of the bottom housing portion, the double-sided tape 703 that serves as a part of the substrate mating assembly, the cut-out in the top housing assembly that accommodates the wicking pad 714, the fluidic channels 724 formed in the tape, and reagent releasers 716 that can be present inside of or place by a user inside of biologic reagent inlets 706.

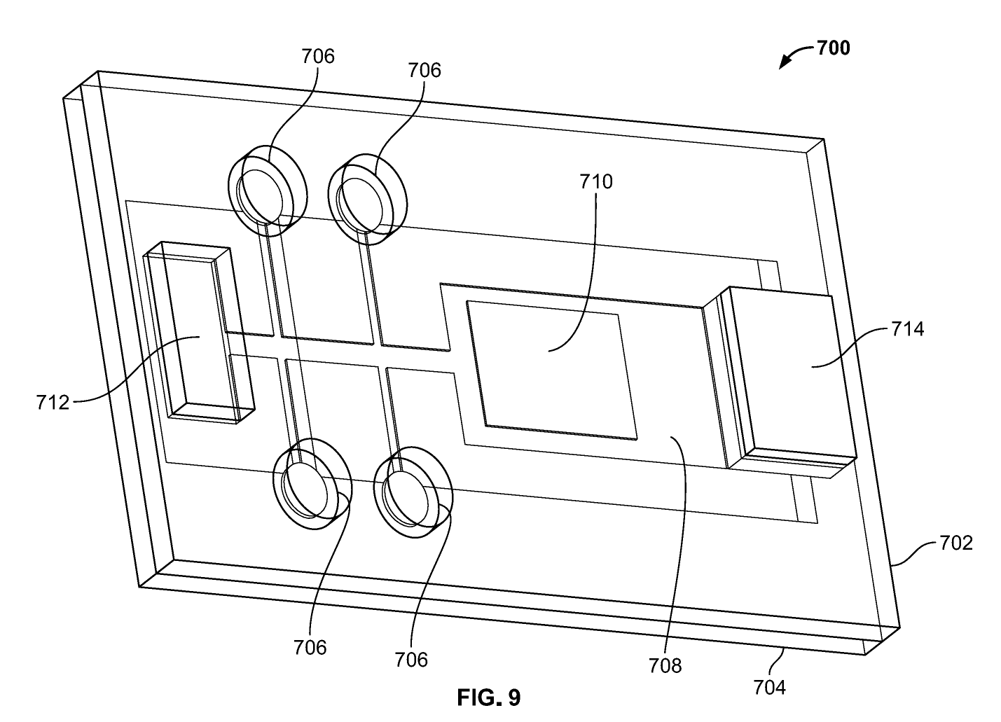

FIG. 9 shows the embodiment of FIG. 8 in assembled form, where again like reference numerals indicate like elements.

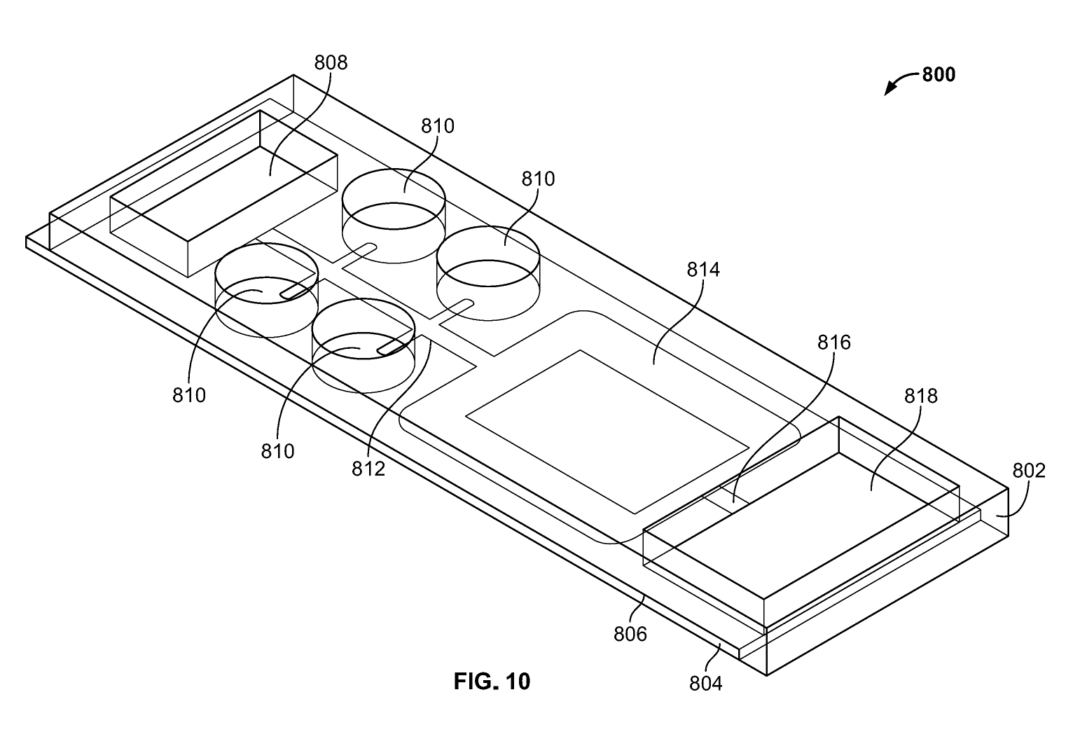

FIG. 10 illustrates an embodiment of the disclosed system 800 where the introducer assembly, the conveyor assembly and the substrate mating assembly are combined into a monolithic piece 802 that can be directly adhered to a substrate 804 with adhesive tape 806 serving as the substrate mating assembly. In this embodiment, fluidic channels 812 and 816 are defined by piece 802, substrate 804 and cutouts in the tape 806. The sample treatment portion 814 of the conveyor assembly is fluidically connected to wash inlet 808 and reagent inlets 810 by fluidic channel 812 of the introducer assembly. The sample treatment portion 814 of the conveyor assembly is connected to the collector assembly 818 of the conveyor assembly by fluidic channel 816.

Further Examples

A first design did not have capillary channels (see for example, FIG. 7). Addition of capillary channels eliminated gradients, reduced bubble formation, and allowed control over flow rate.

In a second design, several observed system challenges were examined and potential solutions were identified as outlined in Table 1 below:

TABLE 1

| System Challenges | Potential Solutions |
|---|---|
| Initial incomplete wetting | Better wetting cap gap surface (glass on |
| | glass) |
| | Wet channel initially with a fluid with |
| | favorable properties (small contact angle) |
| | Make sure surfaces are clean |
| Removing slide at the end | Less tape contact with the slide |
| | Include release areas on the device that |
| | would minimize bending stresses on slide |
| | Use adhesive solvents (xylene, alcohol, 3M |
| | adhesive remover . . . ) |
| Cell Prep overlapping | Extend cap channel beyond cell prep width |
| with tape | (still within slide width) |
| Background staining | More extensive washing |
| | Less AB in pads |
| | Less Chromogen |
| Leaking | Uniform tape thickness (Single tape piece |
| | preferably laser cut) |
| | Applying appropriate pressure when |
| | laminating housing and slide surfaces to the |
| | tape |
| | Thick tape (50 um is too weak, 100 um is |
| | good) |
| Streaks of reacted 3Ab | Extend cap channel beyond slide width |
| from its well | Load conj pad with less 3Ab |
| | Flow more buffer through 3Ab conj well |
| Formation of air bubbles | Constriction at outlet tends to make bubbles |
| when fluid is depleted | form from the outlet side rather than the inlet |
| from wells | which then start moving towards the inlet |
| | direction (Can be pushed to the wicking pad |
| | when next well is loaded). Less problematic |
| | than bubbles forming at the inlet |
| Slide cleanliness | Extend channel walls beyond the slide width |

In a third design having a smaller footprint (see, for example, FIG. 10), the housing is same size as a slide the slide. Capillary channels were brought closer to fit everything on “slide size”. The assembly strategy for the prototype was as follows:
Cut plastic with laser cutter.
Cut tape with laser cutter. Place wet paper towel over tape to prevent burning
Clean cut plastic with alcohol wipe
Use tweezers to place tape layer
Peel backing and adhere clean dry Superfrost Plus slide
Cut wicking pad to size and place

Conclusion: Initial fluid fill inadequate and fluid exchange exhibits streaks.

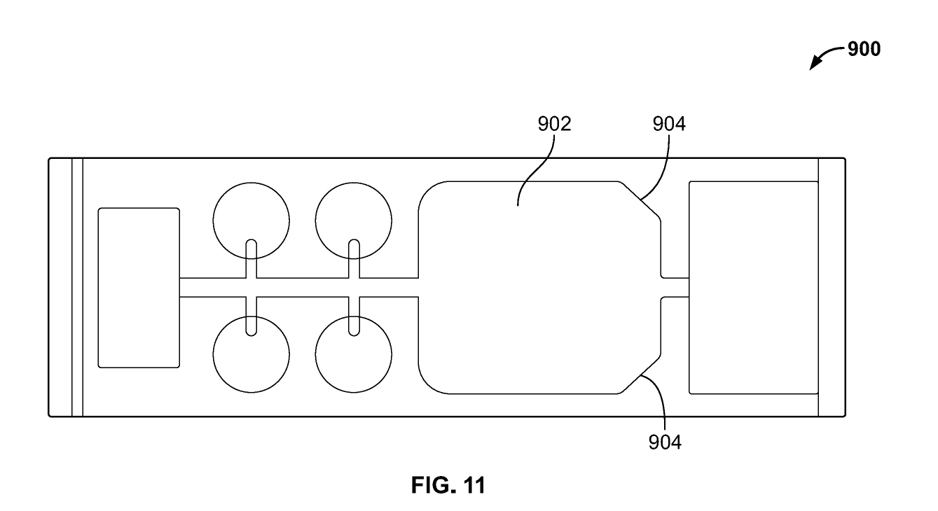

In a fourth design as illustrated in FIG. 11 the geometry of the sample treatment portion 902 of the system 900 was changed to include 45 degree portions 904 near outlet leading to the wicking pad, and the assembly procedure was altered as follows:
Cut plastic (plexiglass) with laser cutter.
Cut tape with laser cutter. Place wet paper towel over tape to prevent burning
Clean cut plastic with alcohol wipe
Use tweezers to place tape layer
Use Surfactant, Reaction Buffer, or abstain from wetting the plexi surface.
Peel backing and adhere clean dry Superfrost Plus slide
Cut wicking pad to size and place

Conclusions: Surfactant wetting of plexiglass improves slide wetting in flow cell. Geometry hinders filling at corners of the outlet

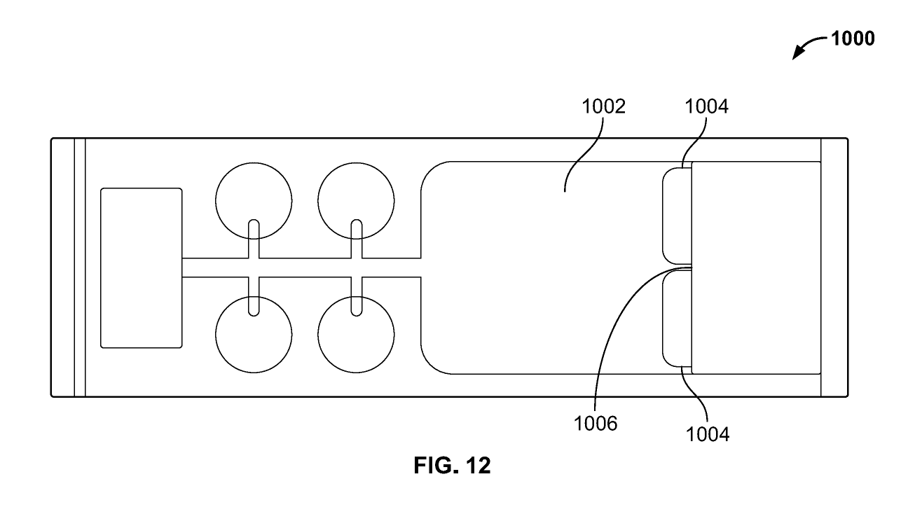

In a fifth design as illustrated in FIG. 12: the geometry of the sample treatment portion 1002 of the system 1000 was changed to include fluid channels at the edges 1004 of the sample treatment portion, and a central fluid channel 1006, were added to try to alleviate incomplete corner filling. The assembly strategy was as follows:
Cut plastic with laser cutter
Cut tape with laser cutter. Place wet paper towel over tape to prevent burning
Clean cut plastic with alcohol wipe
Use tweezers to place tape layer
Use Surfactant, Reaction Buffer, or abstain from wetting the plexi surface.
Peel backing and adhere clean dry Superfrost Plus slide
Cut wicking pad to size and place

Conclusion: Surfactant Wetting of plexiglass improves slide wetting in flow cell. Geometry aids filling corners and along edges. Fluid exchange biases side of introduction.

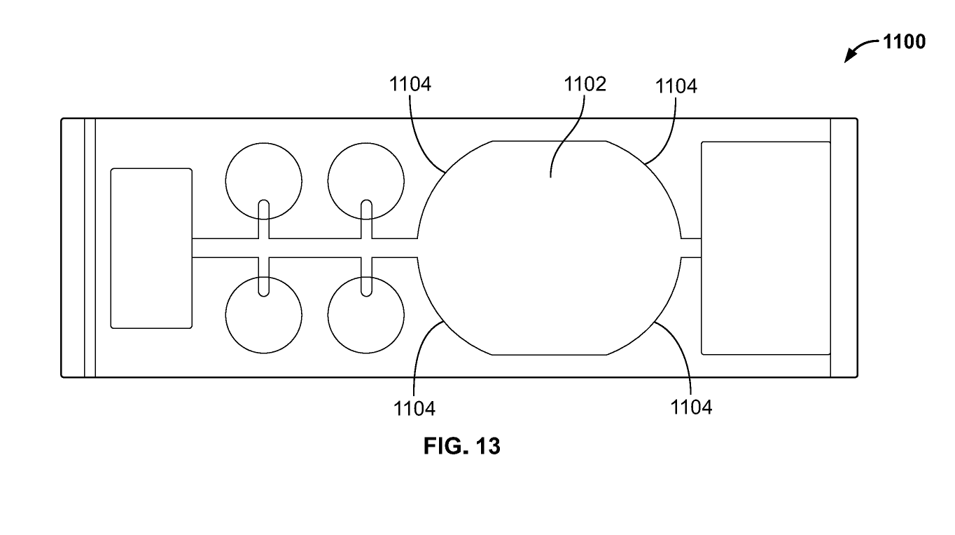

In a sixth design, as shown in FIG. 13, the geometry of the sample treatment portion 1102 of the system 1100 was changed to include larger radius, rounded corners 1104 (such as a radius that is at least 30% of the sample treatment portion's width. The assembly strategy for this prototype was as follows:
Cut plastic with laser cutter
Cut tape with laser cutter. Place wet paper towel over tape to prevent burning
Clean cut plastic with alcohol wipe
Use tweezers to place tape layer
Use Surfactant, Reaction Buffer, or abstain from wetting the plexi surface.
Peel backing and adhere clean dry Superfrost Plus slide
Cut wicking pad to size and place

Conclusions: Surfactant wetting of plexiglass improves slide wetting in flow cell. Geometry aids filling corners and along edges, but still had some filling challenges.

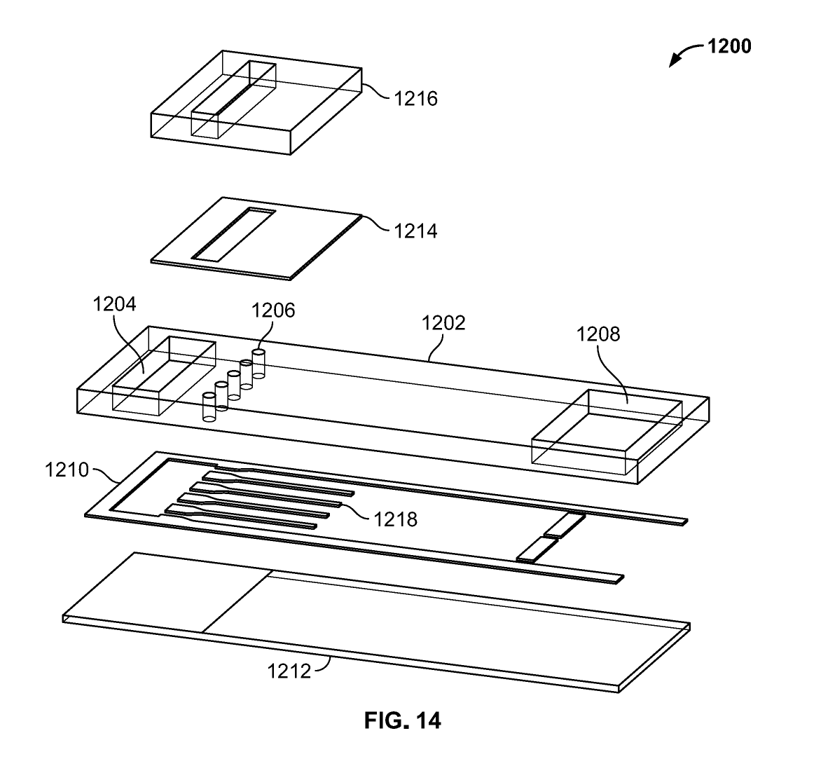

In a seventh design as shown in FIG. 14, the system 1200 included a housing 1202 that included a wash inlet 1204, a set of multiple reagent inlets 1206, and a channel (and capillary space) forming adhesive layer 1210 that included multiple parallel channels located correspondingly to the multiple reagent inlets, but also fluidically connected to the wash inlet and the collector assembly 1208. The adhesive layer which is double-sided and can be pre-assembled to housing 1202 can be protected on its other (lower) surface until a substrate 1212 is adhered to the housing to form the functional system. The system of this embodiment further included a concentrated reagent cap 1216 that could be attached to a top surface of the housing using a second adhesive layer 1214 that includes a passage to fluidically connect the reagent cap 1216 and the reagent inlets 1206. Because biologic reagents such as antibodies are often heat labile, this design permits subjecting the assembly minus the reagent cap and second adhesive layer to high temperature steps. Furthermore, because the cap can be removed and replaced with a second (or more) cap, in one embodiment, the system can be provided as a kit of the housing assembly with the adhesive layer protected by a covering until attachment to a substrate along with one or more reagent caps that can be, for example, numbered to assist a user in carrying out a predetermined sample treatment protocol. The reagent caps can also be pre-assembled with the second adhesive layer and include a protective covering of one side of the adhesive layer that is removed when the cap is place onto the system. This prototype was assembled and tested as follows:
Cut plastic with laser cutter
Cut tape with laser cutter. Place wet paper towel over tape to prevent burning
Clean cut plastic with alcohol wipe
Use tweezers to place tape layer
Use Reaction buffer to fully wet fluid facing surface of slide.
Allow slide to dry fully.
Use Reaction Buffer to wet the surface of the fluid facing side of the plexi
glass.
Peel backing and adhere clean dry Superfrost Plus slide
Cut wicking pad to size and place
Pipette 400 uL Dyed Reaction Buffer to wash reservoir and observe
Peel backing from reagent cap and place on flow cell.
Add 200-400 uL Reagent to cap

Conclusion: Wash fluid fills completely and rapidly. Fluid exchange with reagent is effective, however, even application over all reagent inlet holes helps minimize reagent concentration gradients. Additional placement features (e.g. dowel pin holes) to help position the reagent cap could assist in properly locating the cap over the reagent inlet holes.

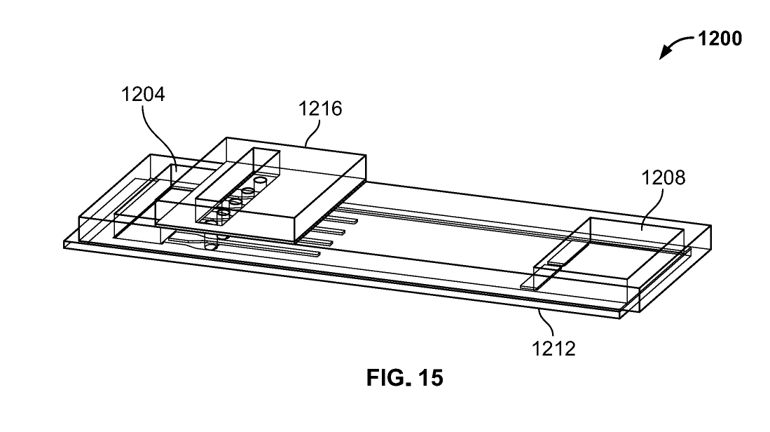

FIG. 15 shows the embodiment of FIG. 14 in assembled form, where like reference numerals correspond to like elements.

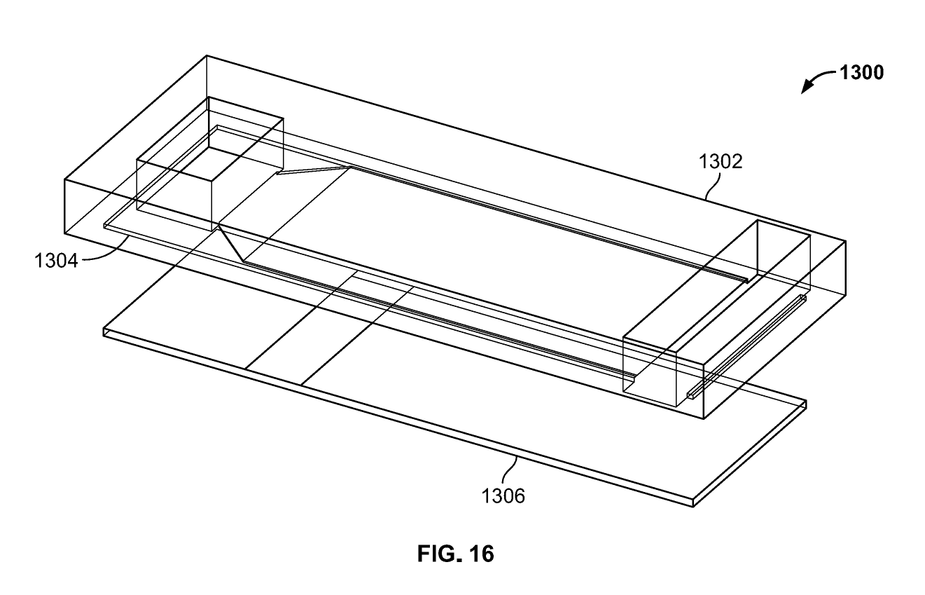

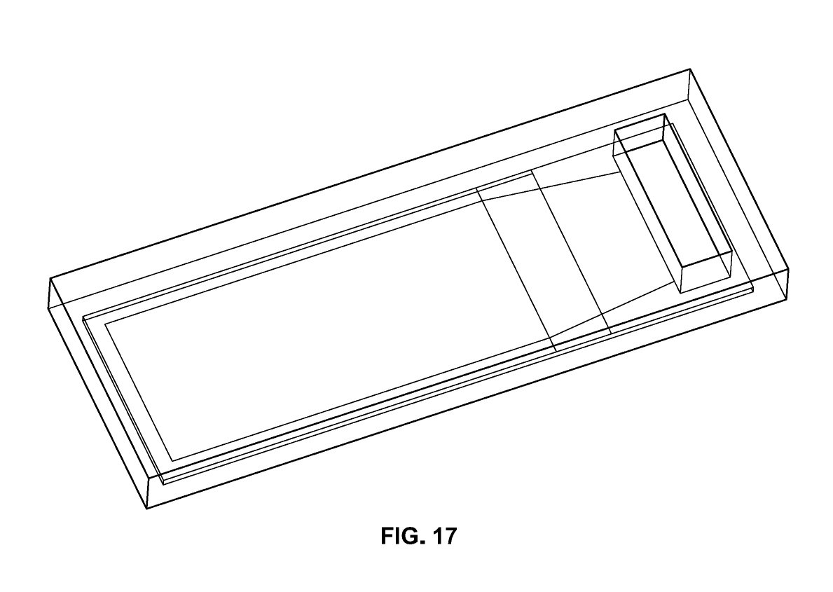

FIG. 16 shows a simple design wherein the system 1300 includes a housing 1302 including a thin step 1304 in the housing that accepts the substrate. A non-reactive grease (like Krytox) can then be used to create a seal between the substrate and the housing. The entire monolithic combination of the introducer assembly, the conveyor assembly and the substrate mating assembly mates right over the slide as shown in FIG. 17, which shows the embodiment of FIG. 16 in assembled form.

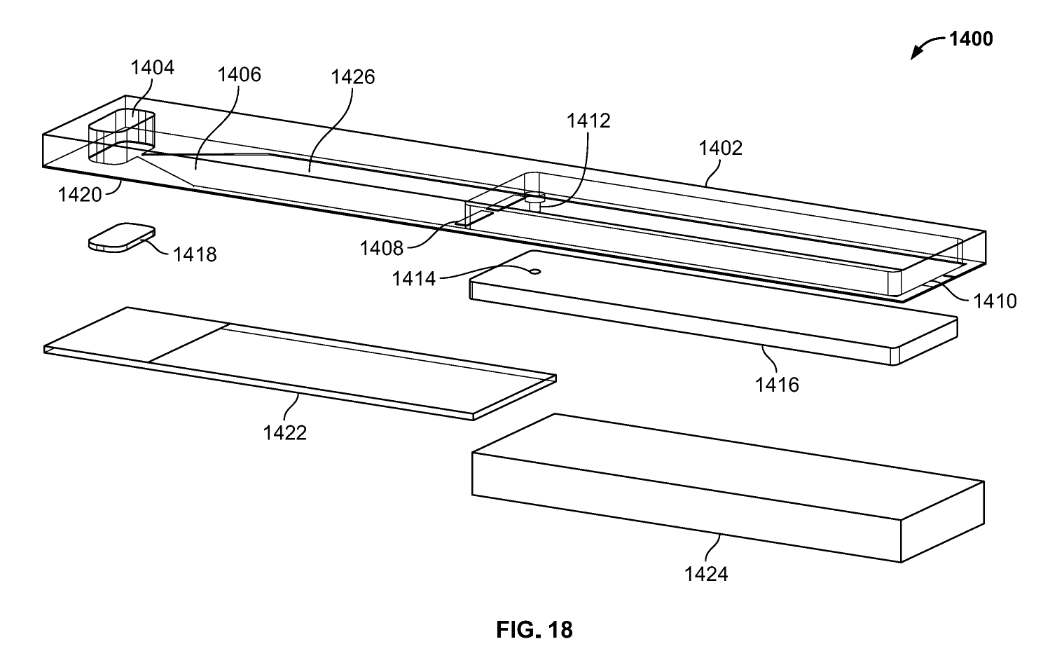

FIG. 18 shows an embodiment of a system 1400 designed to accommodate a larger wicking pad 1416. In this embodiment, a top housing 1402, that includes an inlet 1404 that is fluidically coupled to a diffuser section 1406 (see also the embodiment of FIG. 16 for this feature) that may spread the reagent more evenly across the substrate within the sample treatment portion 1426 of the conveyor assembly. A center and edge fluidic pass through 1408 (see also the embodiment of FIG. 12 for this feature) leads to the collector assembly. In this instance, the collector assembly includes a wicking pad 1416 having a hole 1414 that mates to alignment pin 1412. The collector assembly in this embodiment further includes vent 1410 to permit air to be displaced from the collector assembly. Another additional feature of this embodiment is the porous material 1418 placed inside inlet 1404 to help reduce bubble formation. Again, a double sided adhesive layer (which can be preassembled with the top housing 1402 and protected with a cover until the system is assembled for use) is used to connect the substrate 1422 to the housing. In addition, the adhesive layer is used to connect the top housing to a support block 1424 for the wicking pad.

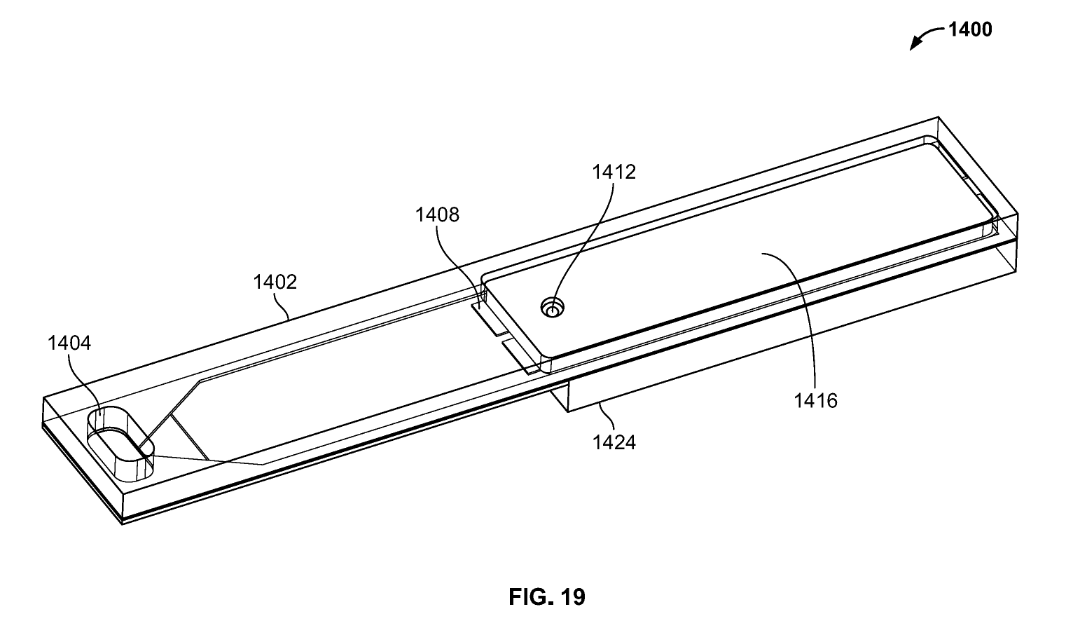

FIG. 19 shows the embodiment of FIG. 18 in assembled form, where like reference numerals correspond to like elements.

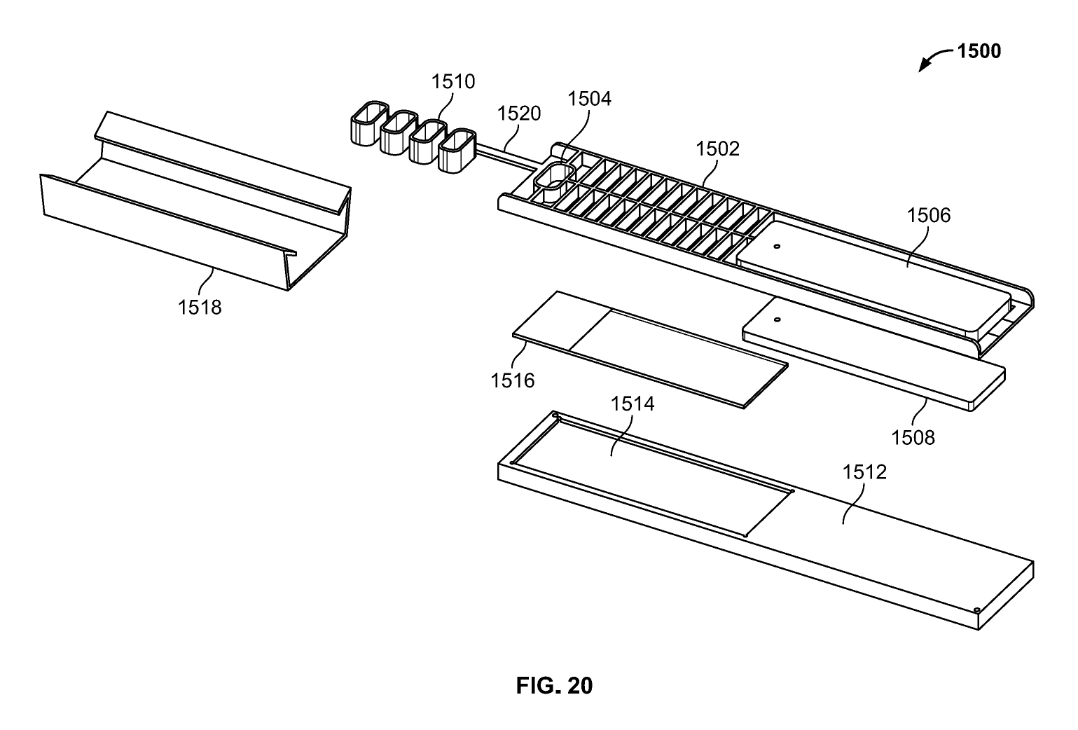

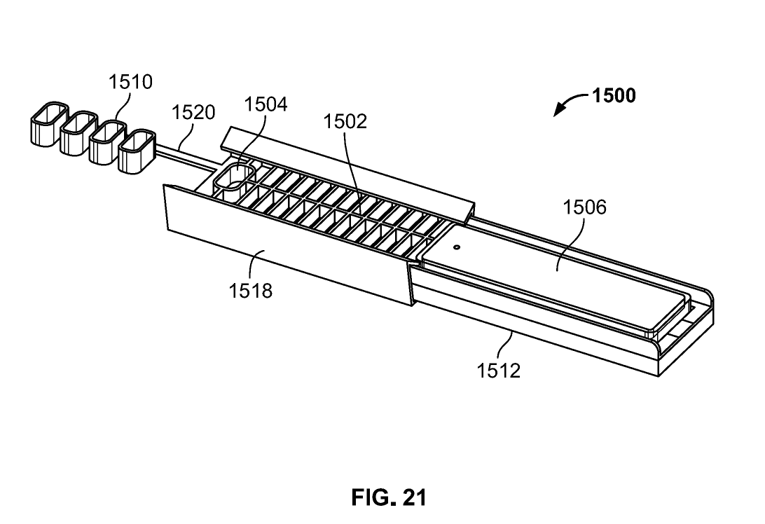

FIG. 20 shows a further embodiment, similar to the embodiment of FIG. 18, where the system 1500 includes a top housing 1502 (which in this case is injection molded plastic) and the flow channel is impressed into the mold. A “living hinge” 1520 allows pre-packed chemicals 1510 to be moved over the fluid inlet 1504. The top housing 1502 also includes a recess 1506 to accommodate the wicking pad 1508. The embodiment further includes a bottom housing 1512 with a recess 1514 configured to accept a substrate 1516, and the embodiment further includes a clamping assembly 1518 that serves to hold the entire assembly together as shown in FIG. 21, where like reference numerals correspond to like elements. Not shown are locating bumps for proper alignment of the bottom and top housings. There is room in the wicking pad chamber for it to expand, but there is also a locating pin in the chamber to prevent the pad from moving around. There can also be an exit channel past the wicking pad to allow for displaced air. The slide sits slightly proud of top surface of the bottom housing in the recess. A sealing member such as an adhesive layer or grease are optional if the plastic from which the assembly is molded is soft enough. As with other embodiments already discussed, indicia can be added to, for example, each of the pre-packed chemicals so that they are labeled with the numerical order in which they are to be used.

FIG. 22 shows a particular embodiment of a 3-dimensional reagent releaser for releasing multiple reagents in succession. The releaser can be placed within a capillary channel and as, for example, when a buffer is flowed past the releaser, the releaser dissolves to permit the different reagents to reach the cellular biological sample.

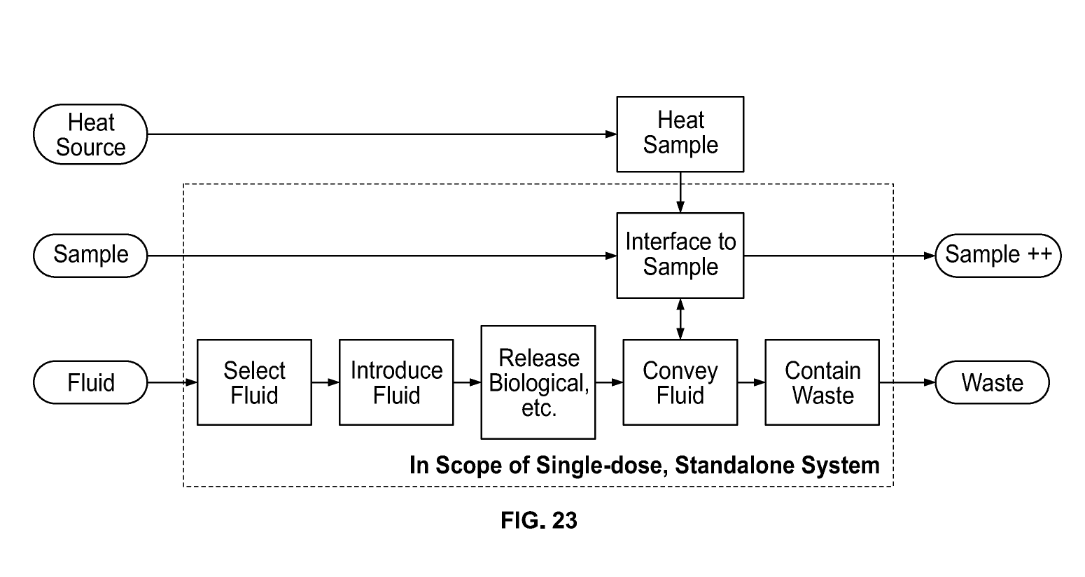

FIG. 23 shows a process diagram showing a general workflow for immunohistochemical (IHC) staining process that can be carried out using the disclosed system according to certain embodiments.

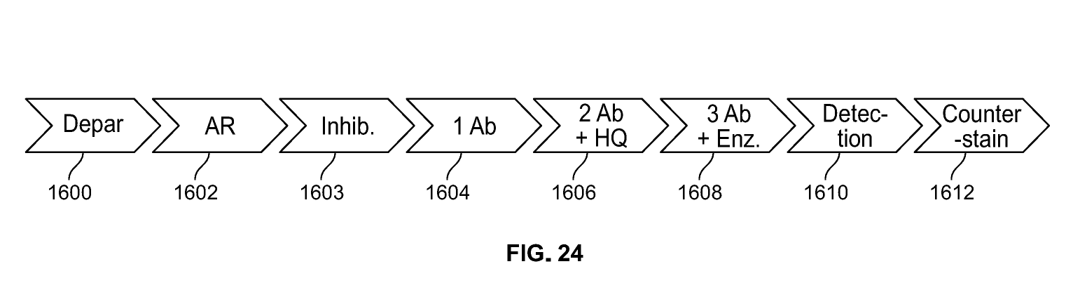

FIG. 24 shows a generalized IHC protocol that can be performed, for example, on a formalin-fixed paraffin-embedded tissue sample. Such a protocol can, at least in part, be performed using the disclosed system according to certain embodiments. At step 1600, the sample is de-paraffinized, a step that may be performed separately before mounting a substrate bearing the tissue sample to the disclosed system. At step 1602, antigen retrieval, which is typically accomplished with head and/or pressure, can be performed using the disclosed system in an embodiment as discussed further below. At step 1603, an inhibitor may be added to help prevent non-specific binding of the primary antibody added in step 1604. If the primary antibody is directly detectable (such as by fluorescence microscopy) steps 1606 and 1608 are optional. If not, these next two steps can be used for signal amplification prior to detection at step 1610. Typically, a counterstain is added to enhance contrast between an IHC detected antigen at step 1612. IHC staining can be used to detect particular antigens (such as biomarkers for disease) in a cellular sample, to detect viral particles and to detect certain pathogenic bacteria.

### Integration of Heating to a POC IHC Device

It is generally accepted that some IHC assays will require a “hot step” to facilitate binding of antibody to antigen or to create optimal reaction conditions for enzymatic detection steps as part of an assay detection stack. In autostainers, this is typically done as a function of the instrument (e.g. a heater plate for the slide, temperature control of the overall instrument, or a temperature controlled staining fluid). For manual staining processes these steps may be performed on a hot plate or in an incubation chamber.

When compared to methods performed manually, the POC device described here may be used in a similar manner, but with some unique attributes. For example, the POC device housing provides an evaporative barrier. When a slide without coverage is placed on a hotplate, there is a large surface area for evaporation of the fluid on the slide. However, when the POC device is placed on the slide, and then placed on a hotplate, the exposed surface area of fluid is greatly reduced.

In addition, the POC device in some embodiments may be compatible with incubation chambers. In either the configuration where the reagents are stored in a second piece of the cartridge assembly or the reagents are packaged as lyophilized solids on the POC device, an incubation chamber may be used. In this configuration, an antigen retrieval fluid is applied via the introduction port on the POC device to wet out the slide and tissue within the capillary gap space. At that point, the entire assembly (Slide+Fluid+POC device) may be placed in the incubation chamber. The advantage is that due to the coverage provided by the device, evaporation rates can be lower than uncovered slides. In addition, since the device has a reservoir to hold additional fluid the device may replenish fluid on the slide and tissue automatically during hot incubation. Finally, this device does not preclude the use in a pressurized incubation chamber.

Another way that heating may be incorporated into the POC device is via the integration of a thin-film heater into the device. During manufacturing of the top plate of the device, a coating of a conductive thin film may be applied. Examples include but are not limited to indium tin oxide (ITO), SiOiCr, Nichorme (NiCr), or Tantalum Nitride (TaN).

Compatible materials (substrate) for the POC device may include acrylics, polycarbonates, glass, polyether ether ketone (“PEEK”), cyclic olefin copolymer (“COC”), and PDMS. Methods of manufacture include direct ion beam sputter coating (particularly for a glass substrate), lamination, or the addition of an epoxy to the POC device surface. For surface treatment, the heater may be built up on the POC device surface while for other methods, the heater is fabricated separately and then bonded to the surface of the POC device facing the fluid, tissue, and microscope slide.

Patterns include continuous thin film surface, grid patterning of metal or metal oxide, or a wound wire pattern on the surface. The differences include the ability to deliver a high-power density for patterned wire heaters and the ability to create heating gradients with a thin film layer depending upon the placement of bus bars. In this device, a thermal gradient may be used to enhance mixing as molecular diffusion will be increased across the temperature gradient as well as bulk transport phenomenon to alleviate the temperature gradient.

Insulation of the heater may be achieved by the application of another thin film layer (SiO2 for example) or the lamination of a non-conductive polymer layer such as polyethylene terephthalate (“PET”) or Kapton® (a polyimide film available from Dupont).

Bus bars to be included may be sputtered metal, a wraparound conductive metal contact to the other (non-fluid facing) side of the POC top plate, or copper (conductive tape) or conductive epoxy (e.g. the conductive epoxy may be a standard epoxy filled with an electrically conductive material, such as metal elements (for example gold and silver), metalloids, or other material such as carbon, which by filling the standard epoxy results in a conductive epoxy). Suitable conductive epoxies include, without limitation, commercially available silver epoxies, nickel epoxies, chromium epoxies, gold epoxies, tungsten epoxies, alloy epoxies and combinations thereof. In some embodiments, the conductive epoxies are selected from Tra-Duct® 2902 silver epoxy (available from Tra-Con, Inc.) and Applied Technologies 5933 alloy (70/25/5 weight percent Ag/Au/Ni) epoxy (available from Applied Technologies). In other embodiments, the conductive epoxy is an EPDXIES 40-3905 (an electrically conductive epoxy adhesive and coating designed for applications requiring low temperature cures) or an EPDXIES 40-3900 (an electrically conductive epoxy resin filled with pure silver), both available from EPDXIES, Cranston, R.I. In another embodiment, the conductive epoxy is AGCL-823, a silver/silver chloride electrically conductive epoxy, available from Conductive Compounds, Hudson, J.

Relevant operating temperatures for the device may be up to about 120 C for sustained periods of time, with a maximum power density up to about 10 W/in2. Control of heating may be via direct modulation of the DC voltage applied to the heater, or through the use of a pulse width modulation scheme at a fixed DC voltage to be applied. Power may be delivered to the device by connecting a supply to the bus bars or other contact surfaces built off of the bus bars.

Application of mild heating extends the capability and flexibility of the device. For example, for some assays, a mild antigen retrieval step is recommended (about 80 C for about 15 min). This act of unmasking antigens may improve the overall sensitivity of the test result provided when using the POC of the device. In the case of some tissue-based assays, it is required to do some amount of antigen retrieval prior to IHC in order to linearize the epitopes for binding. Without the ability to apply heat, that sub-set of IHC assays would not be compatible with this device.

Various modifications of the disclosure, in addition to those described herein, will be apparent to those skilled in the art from the foregoing description. Such modifications are also intended to fall within the scope of the appended claims. For example, as seen in the various specific embodiments illustrated herein, elements of the introducer assembly, the conveyor assembly and the substrate mating assembly can be mixed and matched in one or more modules that are used to assemble the system for use in preparing a substrate mounted cellular biological sample.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “biological specimen,” “sample,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats and primates), insects, annelids, arachnids, marsupials, reptiles, amphibians, bacteria, and fungi. Biological specimens include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological specimens include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological specimen. In certain embodiments, the term “biological specimen” as used herein refers to a sample (such as a homogenized or liquefied sample) prepared from a tumor or a portion thereof obtained from a subject.

As used herein, the term “slide” refers to any substrate (e.g., substrates made, in whole or in part, glass, quartz, plastic, silicon, etc.) of any suitable dimensions on which a biological specimen is placed for analysis, and more particularly to a “microscope slide” such as a standard 3 inch by 1 inch microscope slide or a standard 75 mm by 25 mm microscope slide. Examples of biological specimens that can be placed on a slide include, without limitation, a cytological smear, a thin tissue section (such as from a biopsy), and an array of biological specimens, for example a tissue array, a cellular array, a DNA array, an RNA array, a protein array, or any combination thereof. Thus, in one embodiment, tissue sections, DNA samples, RNA samples, and/or proteins are placed on a slide at particular locations. In some embodiments, the term slide may refer to SELDI and MALDI chips, and silicon wafers.

As used herein, the terms “stain,” “staining,” or the like as used herein generally refers to any treatment of a biological specimen that detects and/or differentiates the presence, location, and/or amount (such as concentration) of a particular molecule (such as a lipid, protein or nucleic acid) or particular structure (such as a normal or malignant cell, cytosol, nucleus, Golgi apparatus, or cytoskeleton) in the biological specimen. For example, staining can provide contrast between a particular molecule or a particular cellular structure and surrounding portions of a biological specimen, and the intensity of the staining can provide a measure of the amount of a particular molecule in the specimen. Staining can be used to aid in the viewing of molecules, cellular structures and organisms not only with bright-field microscopes, but also with other viewing tools, such as phase contrast microscopes, electron microscopes, and fluorescence microscopes. Some staining performed by the system 2 can be used to visualize an outline of a cell. Other staining performed by the system 2 may rely on certain cell components (such as molecules or structures) being stained without or with relatively little staining other cell components. Examples of types of staining methods performed by the system 2 include, without limitation, histochemical methods, immunohistochemical methods, and other methods based on reactions between molecules (including non-covalent binding interactions), such as hybridization reactions between nucleic acid molecules. Particular staining methods include, but are not limited to, primary staining methods (e.g., H&E staining, Pap staining, etc.), enzyme-linked immunohistochemical methods, and in situ RNA and DNA hybridization methods, such as fluorescence in situ hybridization (FISH).

### ADDITIONAL EMBODIMENTS

### Additional Embodiment 1

A system for preparing a cellular biological sample for analysis, wherein the cellular biological sample is mounted on a substrate, comprising:
a. an introducer assembly configured to receive at least one fluid used to prepare the cellular biological sample for analysis;
b. a conveyor assembly configured to move the at least one fluid across at least a portion of the substrate and bring the at least one fluid in contact with at least a portion of the cellular biological sample; and,
c. a substrate mating assembly configured to hold the substrate against at least a portion of the conveyor assembly.

### Additional Embodiment 2

The system of additional embodiment 1, wherein at least a portion of each of the introducer assembly, the conveyor assembly and the substrate mating assembly are combined in a single, pre-assembled unit.

### Additional Embodiment 3

The system of any of additional embodiments 1 or 2, wherein the substrate comprises a microscope slide.

### Additional Embodiment 4

The system of any of additional embodiments 1 to 3, wherein the introducer assembly comprises one or more fluid inlets.

### Additional Embodiment 5

The system of additional embodiment 4, wherein the introducer assembly comprises two or more fluid inlets.

### Additional Embodiment 6

The system of additional embodiment 5, wherein the introducer assembly comprises indicia that specify the order in the at least one fluid is introduced into the two or more fluid inlets of the introducer assembly.

### Additional Embodiment 7

The system of any of additional embodiments 4 to 6, further comprising a fluid delivery control unit configured to mate with the one or more fluid inlets of the introducer assembly of the system.

### Additional Embodiment 8

The system of additional embodiment 7, wherein the fluid delivery control unit automatically supplies the at least one fluid to the introducer assembly of the system in one or more predetermined amounts at one or more predetermined times.

### Additional Embodiment 9

The system of additional embodiment 8, wherein the at least one fluid, the one or more predetermined amounts and the one or more predetermined times are encoded in indicia on the system and read by an indicia reader of the fluid delivery control unit, causing the fluid delivery control unit to supply the at least one fluid to the introducer assembly according to the one or more predetermined amounts and at the one or more predetermined times.

### Additional Embodiment 10

The system of any of additional embodiments 1 to 9, wherein the introducer assembly further comprises at least one reagent releaser.

### Additional Embodiment 11

The system of additional embodiment 9, wherein the at least one reagent releaser comprises one or more of a dried reagent printed on a surface of the introducer assembly, a dissolvable polymer comprising a reagent, a porous membrane pad comprising a reagent, a particle comprising a reagent, and a blister pack.

### Additional Embodiment 12

The system of any of additional embodiments 1 to 11, wherein the introducer assembly further comprises at least one valve configured to alter a flow pattern of the at least one fluid through the introducer assembly after a pre-determined length of time.

### Additional Embodiment 13

The system of any of additional embodiments 1 to 12, wherein the conveyor assembly comprises a fluid collector assembly.

### Additional Embodiment 14

The system of any of additional embodiments 1 to 13, wherein the conveyor assembly comprises a porous membrane.

### Additional Embodiment 15

The system of any of additional embodiments 1 to 14, wherein the conveyor assembly comprises a capillary channel.

### Additional Embodiment 16

The system of any of additional embodiments 1 to 15, wherein the conveyor assembly comprises at least one capillary channel and at least one porous membrane.

### Additional Embodiment 17

The system of any of additional embodiments 13 to 16, wherein the collector assembly comprises a porous material and is configured to draw the at least one fluid from the introducer assembly, through the conveyor assembly and into the collector assembly.

### Additional Embodiment 18

The system of any of additional embodiments 1 to 17, wherein the substrate mating assembly comprises an adhesive material attached to a surface of the conveyor assembly.

### Additional Embodiment 19

The system of additional embodiment 18, wherein at least one capillary channel is defined by a combination of the substrate, the adhesive material and the surface of the introducer assembly and or the conveyor assembly.

### Additional Embodiment 20

The system of additional embodiment 19, further including a removable covering over the adhesive material that protects the adhesive material until it is used to join the substrate to the conveyor assembly and/or the introducer assembly.

### Additional Embodiment 21

The system of additional embodiment 20, wherein the conveyor assembly and/or the introducer assembly include guide portions that assist a user in combining the substrate with the conveyor assembly and/or the introducer assembly to form a system prepared to accept the one or more fluids.

### Additional Embodiment 22

The system of any of additional embodiments 1 to 21, wherein the substrate mating assembly further comprises a backing plate.

### Additional Embodiment 23

The system of additional embodiment 22, wherein the backing plate comprises a holding portion configured to accommodate the substrate and that is further configured to align the substrate with the conveyor assembly when the backing plate and the conveyor assembly are combined.

### Additional Embodiment 24

The system of any of additional embodiments 1 to 23, wherein the substrate mating assembly further comprises a clamping assembly configured to apply a force that holds the substrate against the substrate mating assembly.

### Additional Embodiment 25

The system of additional embodiments 7 to 24, wherein the clamping assembly is configured to include the fluid delivery control unit.

### Additional Embodiment 26

The system of additional embodiment 7 to 25, wherein the clamping assembly further includes a temperature regulating subsystem.

### Additional Embodiment 27

The system of additional embodiments 1 to 26, wherein the conveying assembly and/or the backing plate further include at least one heating and/or cooling element.

### Additional Embodiment 28

The system of additional embodiment 27, wherein the clamping assembly further includes electrical connectors to connect with the at least one heating and/or cooling element.

### Additional Embodiment 29

A method for preparing a cellular sample for microscopic analysis, wherein the cellular sample is mounted to a microscope slide, comprising:
a. mating the system of any of additional embodiments 1 to 28 with the microscope slide;
b. delivering, through the introducer assembly, a predetermined series of reagents to a sample treatment portion of the conveyor assembly that covers at least a portion of the cellular sample and brings the predetermined series of reagents into contact with the cellular sample; and,
c. removing, successively, the series of reagents from the sample treatment portion into a collector assembly of the conveyor assembly.

### Additional Embodiment 30

The method of additional embodiment 29, wherein the predetermined series of reagent comprises a series of reagents to perform a staining protocol on the cellular sample.

### Additional Embodiment 31

The method of additional embodiment 30, wherein the staining protocol comprises an immunohistochemical staining protocol.

### Additional Embodiment 32

The method of additional embodiment 29, wherein the cellular sample comprises a tissue sample.

### Additional Embodiment 33

A kit, comprising:
a. a system according to any of additional embodiments 1-28; and
b. instructions for use of the system to perform the method of any of additional embodiments 29 to 32.

### Additional Embodiment 34

The kit of additional embodiment 33, further comprising a microscope slide.

### Additional Embodiment 35

The kit of additional embodiment 34, wherein the microscope slide is a microscope slide treated to improve adherence of cells to the microscope slide.

### Additional Embodiment 36

A system for preparing a cellular biological sample for analysis, wherein the cellular biological sample is mounted on a substrate, comprising:
an introducer assembly including at least two fluid inlets, the introducer assembly configured to receive at least one fluid used to prepare the cellular biological sample for analysis;
a conveyor assembly configured to move the at least one fluid across at least a portion of the substrate and bring the at least one fluid in contact with at least a portion of the cellular biological sample; and,
a substrate mating assembly configured to hold the substrate against at least a portion of the conveyor assembly.

### Additional Embodiment 37

The system of additional embodiment 36, wherein the conveyor assembly includes at least one absorbent wicking pad.

### Additional Embodiment 38

The system of additional embodiment 37, wherein the absorbent wicking pad is comprised of a material selected from a cellulose or a hydrogel.

### Additional Embodiment 39

The system of additional embodiment of any of additional embodiments 36 to 38, wherein the substrate mating assembly comprises an adhesive material attached to a surface of the conveyor assembly.

### Additional Embodiment 40

A system for preparing a cellular biological sample for analysis, wherein the cellular biological sample is mounted on a substrate, comprising:
an introducer assembly configured to receive at least one fluid used to prepare the cellular biological sample for analysis;
a conveyor assembly including at least one porous membrane portion, the conveyor assembly configured to move the at least one fluid across at least a portion of the substrate and bring the at least one fluid in contact with at least a portion of the cellular biological sample; and,
a substrate mating assembly configured to hold the substrate against at least a portion of the conveyor assembly.

### Additional Embodiment 41

The system of additional embodiment 40, wherein the conveyor assembly includes at least two porous membrane portions.

### Additional Embodiment 42

The system of any of additional embodiments 40 or 41, wherein the conveyor assembly further comprises a fluid collector assembly.

### Additional Embodiment 43

The system of additional embodiment 42, wherein the fluid collector assembly includes a porous material.

### Additional Embodiment 44

The system of additional embodiment 43, wherein the porous material is a wicking pad.

### Additional Embodiment 45

The system of additional embodiment of any of additional embodiments 40 to 44, wherein the substrate mating assembly comprises an adhesive material attached to a surface of the conveyor assembly.

### Additional Embodiment 46

A system for preparing a cellular biological sample for analysis, wherein the cellular biological sample is mounted on a substrate, comprising:
an introducer assembly including a wash inlet and at least two reagent inlets;
a conveyor assembly including at least two parallel channels in fluidic communication with the at least two reagent inlets and the wash inlet, the conveyor assembly configured to move the at least one fluid across at least a portion of the substrate and bring the at least one fluid in contact with at least a portion of the cellular biological sample; and,
a substrate mating assembly configured to hold the substrate against at least a portion of the conveyor assembly.

1. A system for preparing a cellular biological sample for analysis, wherein the cellular biological sample is mounted on a substrate, comprising:
a. an introducer assembly comprising at least one fluid inlet, the introducer assembly configured to receive at least one fluid used to prepare the cellular biological sample for analysis;
b. a conveyor assembly comprising a fluid collector assembly having a porous material, wherein the conveyor assembly is configured to move the at least one fluid across at least a portion of the substrate and bring the at least one fluid in contact with at least a portion of the cellular biological sample; and,
c. a substrate mating assembly configured to hold the substrate against at least a portion of the conveyor assembly,
wherein at least a portion of each of the introducer assembly, the conveyor assembly, and the substrate mating assembly are combined in a single, pre-assembled unit.

2. The system of claim 1, wherein the introducer assembly comprises two or more fluid inlets.

3. The system of claim 1, further comprising a fluid delivery control unit configured to mate with the at least one fluid inlet of the introducer assembly.

4. The system of claim 3, wherein the fluid delivery control unit automatically supplies the at least one fluid to the introducer assembly of the system in one or more predetermined amounts at one or more predetermined times.

5. The system of claim 4, wherein the at least one fluid, the one or more predetermined amounts and the one or more predetermined times are encoded in indicia on the system and read by an indicia reader of the fluid delivery control unit, causing the fluid delivery control unit to supply the at least one fluid to the introducer assembly according to the one or more predetermined amounts and at the one or more predetermined times.

6. The system of claim 1, wherein the introducer assembly further comprises at least one reagent releaser.

7. The system of claim 6, wherein the at least one reagent releaser comprises one or more of a dried reagent printed on a surface of the introducer assembly, a dissolvable polymer comprising a reagent, a porous membrane pad comprising a reagent, a particle comprising a reagent, and a blister pack.

8. The system of claim 1, wherein the introducer assembly further comprises at least one valve configured to alter a flow pattern of the at least one fluid through the introducer assembly after a pre-determined length of time.

9. The system of claim 1, wherein the conveyor assembly further comprises a capillary channel.

10. The system of claim 1, wherein the collector assembly of the conveyor assembly comprises a porous material and is configured to draw the at least one fluid from the introducer assembly, through the conveyor assembly and into the collector assembly.

11. The system of claim 1, wherein the substrate mating assembly comprises an adhesive material attached to a surface of the conveyor assembly.

12. The system of claim 11, wherein at least one capillary channel is defined by a combination of the substrate, the adhesive material and the surface of the introducer assembly and or the conveyor assembly.

13. The system of claim 1, wherein the substrate mating assembly further comprises a backing plate having a holding portion configured to accommodate the substrate and that is further configured to align the substrate with the conveyor assembly when the backing plate and the conveyor assembly are combined.

14. The system of claim 13, wherein the conveying assembly and/or the backing plate further include at least one heating and/or cooling element.

15. The system of claim 1, wherein the substrate mating assembly further comprises a clamping assembly configured to apply a force that holds the substrate against the substrate mating assembly.

16. The system of claim 1, wherein the conveyor assembly includes at least one absorbent wicking pad.

17. The system of claim 16, wherein the absorbent wicking pad is comprised of a material selected from a cellulose or a hydrogel.

18. A system for preparing a cellular biological sample for analysis, wherein the cellular biological sample is mounted on a substrate, comprising:
an introducer assembly configured to receive at least one fluid used to prepare the cellular biological sample for analysis;
a conveyor assembly including at least one porous membrane portion, the conveyor assembly configured to move the at least one fluid across at least a portion of the substrate and bring the at least one fluid in contact with at least a portion of the cellular biological sample; and,
a substrate mating assembly configured to hold the substrate against at least a portion of the conveyor assembly.

19. The system of claim 18, wherein the conveyor assembly further comprises a fluid collector assembly, wherein the fluid collector assembly comprises a porous material.

20. A system for preparing a cellular biological sample for analysis, wherein the cellular biological sample is mounted on a substrate, comprising:
an introducer assembly including a wash inlet and at least two reagent inlets;
a conveyor assembly including at least two parallel channels in fluidic communication with the at least two reagent inlets and the wash inlet, the conveyor assembly configured to move the at least one fluid across at least a portion of the substrate and bring the at least one fluid in contact with at least a portion of the cellular biological sample; and,
a substrate mating assembly configured to hold the substrate against at least a portion of the conveyor assembly.

21. The system of claim 20, wherein the at least two channels are parallel channels.
